(19) United States
(12) Patent Application Publication
(10) Pub. No.: US 2012/0210108 A1
(43) Pub. Date: Aug. 16, 2012

(54) SEMICONDUCTOR DEVICE

(76) Inventors: Kenji ISHIZUKA, Yokohama-shi (JP); Tokumasa Hara, Kawasaki-shi (JP); Shoichiro Hashimoto, Tokyo (JP)

(21) Appl. No.: 13/367,708

(22) Filed: Feb. 7, 2012

(30) Foreign Application Priority Data
Feb. 14, 2011 (JP) 2011-029104

(51) Int. Cl. G06F 9/44

(52) U.S. Cl. 712/245

(57) ABSTRACT

According to one embodiment, a semiconductor device includes a first sequencer and a second sequencer. The first sequencer operates at a first frequency. The second sequencer operates at a second frequency that is higher than the first frequency. In the first mode, the first sequencer operates in accordance with an instruction received from an external apparatus, and the second sequencer operates under control of the first sequencer. In the second mode, the second sequencer operates in accordance with an instruction received from the external apparatus, and the operation of the first sequencer is stopped.

### CROSS-REFERENCE TO RELATED APPLICATIONS

This application is based upon and claims the benefit of priority from prior Japanese Patent Application No. 2011-029104, filed Feb. 14, 2011, the entire contents of which are incorporated herein by reference.

### FIELD

Embodiments described herein relate generally to a semiconductor device.

### BACKGROUND

A semiconductor device with a NAND flash memory and SRAM embedded therein has been known. Such a semiconductor device includes two sequencers controlling the NAND flash memory and SRAM, respectively.

### BRIEF DESCRIPTION OF THE DRAWINGS

FIG. 1 is a block diagram of a semiconductor device according to a first embodiment;

FIG. 2 is a circuit diagram of a switch unit according to the first embodiment;

FIG. 3 is a table illustrating operation of the switch unit according to the first embodiment;

FIG. 4 is a circuit diagram of a register unit according to the first embodiment;

FIG. 5 is a flowchart illustrating operation of the register unit according to the first embodiment;

FIG. 6 to FIG. 8 are timing charts illustrating operation of the semiconductor device according to the first embodiment;

FIG. 9 is a block diagram of a semiconductor device according to a second embodiment;

FIG. 10 is a circuit diagram of a register unit according to the second embodiment;

FIG. 11 is a block diagram of a partial area of the semiconductor device according to the second embodiment;

FIG. 12 and FIG. 13 are flowcharts illustrating operation of the semiconductor device according to the second embodiment;

FIG. 14 is a timing chart illustrating the operation of the semiconductor device according to the second embodiment;

FIG. 15 and FIG. 16 are a flowchart and a timing chart, respectively, illustrating operation of a semiconductor device according to a third embodiment; and

FIG. 17 is a block diagram of a semiconductor device according to a modification of the first to third embodiments.

### DETAILED DESCRIPTION

In general, according to one embodiment, a semiconductor device includes a first sequencer and a second sequencer. The first sequencer operates at a first frequency. The second sequencer operates at a second frequency that is higher than the first frequency. In the first mode, the first sequencer operates in accordance with an instruction received from an external apparatus, and the second sequencer operates under control of the first sequencer. In the second mode, the second sequencer operates in accordance with an instruction received from the external apparatus, and the operation of the first sequencer is stopped.

### FIRST EMBODIMENT

A semiconductor device according to a first embodiment will be described.

### 1. General Configuration of the Semiconductor Device

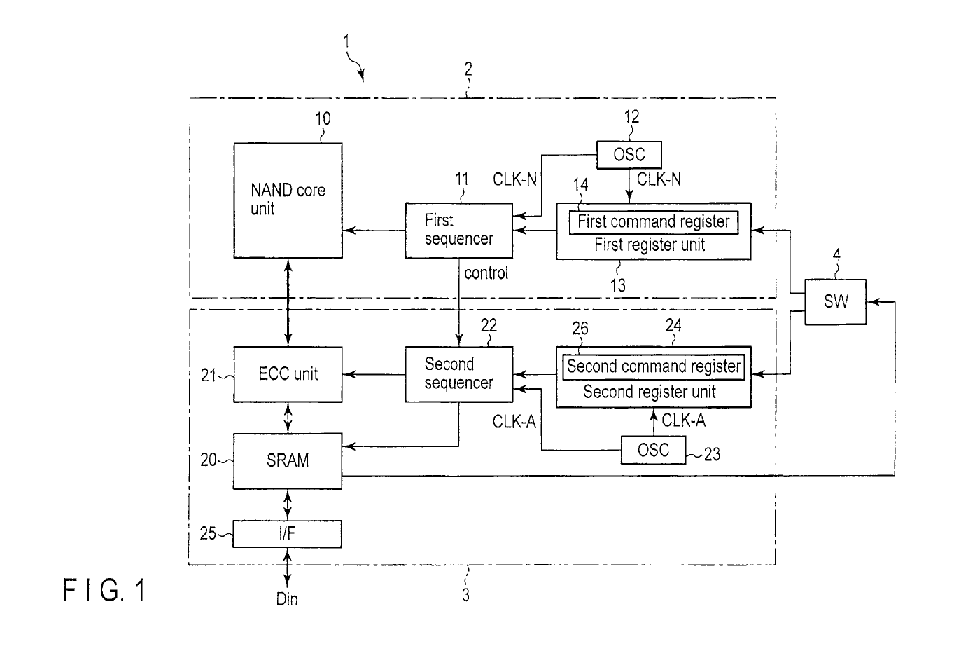

FIG. 1 is a block diagram of a semiconductor device according to the present embodiment. As shown in FIG. 1, a semiconductor device 1 generally includes a NAND flash memory 2, static random access memory (SRAM) unit 3, and a switch unit 4. These components are formed on the same semiconductor substrate and integrated in one chip. Each circuit block will be described below.

### 1.1 Configuration of the NAND Flash Memory 2

The NAND flash memory 2 functions as a main storage unit of the semiconductor device 1. As shown in FIG. 1, the NAND flash memory 2 includes a NAND core unit 10, a first sequencer 11, an oscillator 12, and a first register unit 13.

The NAND core unit 10 is a block with a function to store data, and includes a memory cell array, a row decoder, and a sense amplifier (none of these components are shown in the drawings). The memory cell array includes a plurality of memory cell transistors capable of holding data. The memory cell transistors are arranged in a matrix. The row decoder selects any of the rows in the memory cell array. During a read, the sense amplifier senses and amplifies data read from a memory cell transistor selected by the row decoder. The sense amplifier then outputs the data to the SRAM unit 3. Furthermore, during a write, the sense amplifier temporarily holds write data input by the SRAM unit 3. The sense amplifier then writes the data to the memory cell transistor selected by the row decoder.

The first register unit 13 sets and holds commands input by an external host apparatus via the switch unit 4 and the SRAM unit 3. Examples of such commands include a write command, a read command, and an erase command for the NAND flash memory 2. The first register unit 13 includes first command registers for the respective commands. The first command register 14 determines whether command setting conditions for setting a command are met. When the command setting conditions are met, the corresponding command is set.

The Oscillator 12 generates a clock CLK-N.

The first sequencer 11 controls operation of the NAND flash memory 2 based on a command set by the first register unit 13 and in synchronism with clock CLK-N. That is, the first sequencer 11 carries out processing required to write data to the NAND flash memory 2, read data from the NAND flash memory 2, and erase data in the NAND flash memory 2. Based on this processing, the NAND core unit 10 performs operation. Moreover, the first sequencer 11 controls operation of a second sequencer included in the SRAM unit 3. This will be described below in detail.

1.2 Configuration of the SRAM unit Now, the SRAM unit 3 will be further described with reference to FIG. 1. The SRAM unit 3 includes SRAM 20. Whereas the NAND flash memory 2 functions as a main storage for the semiconductor device 1, SRAM 20 functions as a buffer memory for the semiconductor device 1.

As shown in FIG. 1, the SRAM unit 3 includes SRAM 20, an ECC unit 21, a second sequencer 22, an oscillator 23, a second register unit 24, and an interface 25.

The SRAM 20 functions as a buffer memory as described above. That is, during a read, SRAM 20 temporarily holds data read from the NAND flash memory 2, and then outputs the data to an external apparatus. On the other hand, during a write, SRAM 20 temporarily holds write data input by a host apparatus, and then outputs the data to the NAND flash memory 2. Furthermore, SRAM 20 holds a boot code for starting the semiconductor device 1. Moreover, SRAM 20 transfers an instruction input by the host apparatus to the switch unit 4.

The ECC unit 21 is connected to the NAND core unit 10 via a data bus to transmit and receive data to and from the NAND core unit 10. The ECC unit 21 detects and corrects errors in data and generates parities (these operations are sometimes collectively referred to as an ECC process). That is, during a read, the ECC unit 21 detects and corrects errors in data read from the NAND flash memory 2. The FCC unit 21 then stores the corrected data in SRAM 20. On the other hand, during a write, the ECC unit 21 generates parities for write data. The ECC unit 21 then transfers the write data and the parities to the NAND core unit 10.

The second register unit 24 sets and holds a command in accordance with an instruction input by the host apparatus via the switch unit 4 and SRAM 20. However, commands that can be set by the second register unit 24 correspond to operations completed in the SRAM unit 3. That is, commands requiring operations of the NAND flash memory 2 are not set in the second register unit 24. Such commands are set in the first register unit 13. Examples of commands set in the second register unit 24 include a lock instruction and an unlock instruction which accesses SRAM 20. The lock instruction is an instruction for writing lock information into a desired area of SRAM 20 to inhibit writing data and erasing data in at least a part of the NAND core unit 10. The unlock instruction is an instruction for deleting the lock information for the NAND core unit 10 written into the SRAM 20. The second register unit 24, for example, includes second command registers 26 for the respective commands. As is the case with the first command register 14, in the second command register 26 where particular setting conditions are met, the corresponding command is set.

The oscillator 23 generates a clock CLK-A. The clock CLK-A has a higher frequency than the clock CLK-N generated by the oscillator 12.

If any command is set in the first register unit 13, the second sequencer 22 operates based on the corresponding instruction from the first sequencer 11 to control the SRAM unit 3. That is, the first sequencer 11 functions as a master sequencer, and the second sequencer 22 functions as a slave sequencer. Thus, in this case, the starting (and possibly the stopping) of the second sequencer 22 is managed by the instruction from the first sequencer 11. Furthermore, what operation the second sequencer 22 performs is based on the instruction from the first sequencer 11. On the other hand, if any command is set in the second register unit 24, the second sequencer 22 operates based on the command to control the SRAM unit 3. That is, in this case, the second sequencer 22 operates independently of the first sequencer 11 instead of being managed by the first sequencer 11. This will be described below in detail.

The interface 25 transmits and receives signals to and from the host apparatus. That is, the interface 25 receives data and instructions provided by the host apparatus, and transfers the data and instructions to SRAM 20. The interface 25 also outputs data in SRAM 20 to an external apparatus.

### 1.3 Switch Unit 4

Now, the switch unit 4 will be described. The switch unit 4 receives an external block EX-CLK input by the host apparatus, and permits and inhibits setting of commands in the first register unit 13 and the second register unit 24. With command setting permitted by the switch unit 4, provision of an instruction allows the first and second register unit 13 and 24 to enable the command to be set. The external clock EX-CLK is, for example, a write enable signal WEn. The semiconductor device 1 can load an instruction input by the host apparatus on the rising edge and/or the falling edge of the write enable signal WEn.

### 2. General Operation of the Semiconductor Device 1

Now, the operation of the semiconductor device 1 configured as described above will be generally described in brief. As described above, in the semiconductor device 1 according to the present embodiment, the NAND flash memory 2 functions as a main storage unit. SRAM 20 functions as a buffer memory.

Thus, if data is read from the NAND flash memory 2 to an external apparatus, when first the host apparatus inputs an instruction to the semiconductor device 1, data is read from the memory cell array in the NAND core unit 10. This operation is performed under the control of the first sequencer 11. Subsequently, under the control of the second sequencer 22 functioning as a slave of the first sequencer 11, the ECC unit 21 reads data from the NAND core unit 10 and carries out an ECC process. The ECC unit then stores the data subjected to the ECC process in SRAM 20. Moreover, when the host apparatus inputs an instruction to the semiconductor device 1, data in SRAM 20 is output to an external apparatus via the interface 25 under the control of the second sequencer 22.

A reverse operation is performed when data is written to the NAND flash memory 2. That is, when the host apparatus inputs an instruction to the semiconductor device, write data input by the host apparatus is stored in SRAM 20 under the control of the second sequencer 22 functioning as a slave of the first sequencer 11. Then, when the host apparatus inputs a further instruction to the semiconductor device, the FCC unit 21 carries out an ECC process, and transfers the write data and parities to the NAND core unit 10. Thereafter, the NAND core unit 10 writes the data to memory cell transistors under the control of the first sequencer 11.

### 3. Details of the Switch Unit 4

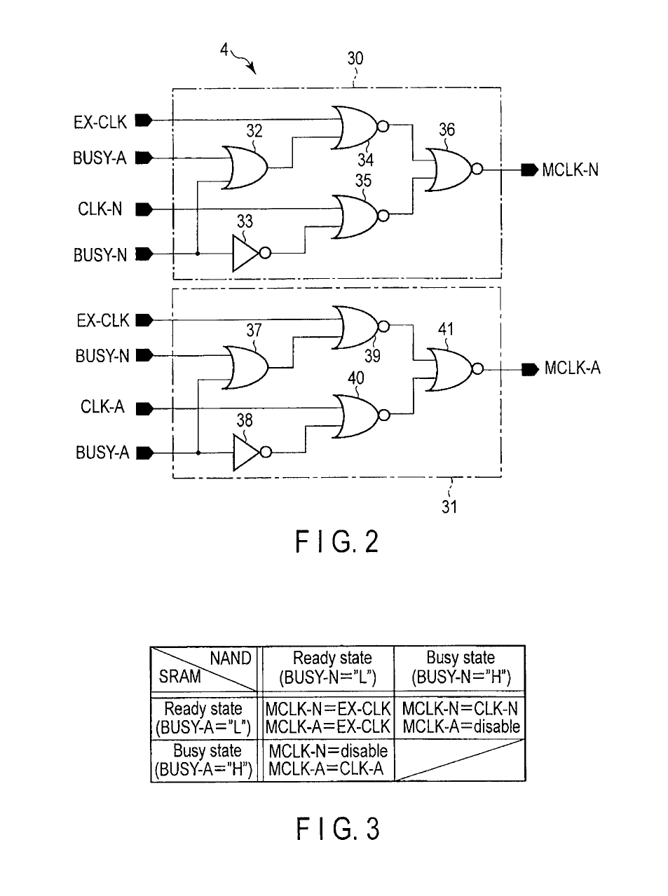

Now, the above-described switch unit 4 will be described in detail with reference to FIG. 2. FIG. 2 is a circuit diagram of the switch unit 4. As shown in FIG. 2, the switch unit 4 generally includes a first switch unit 30 and a second switch unit 31.

The first switch unit 30 is a block for controlling success and failure in setting of a command in the first register unit 13. As shown in FIG. 2, the first switch unit 30 comprises an OR gate 32, an inverter 33, and NOR gates 34 to 36.

The OR gate 32 performs a logical OR operation on a busy signal BUSY-A and a busy signal BUSY-N. The signal BUSY-A indicates whether or not the SRAM unit 3 is in the busy state. If any command is set in the second register unit 24, the SRAM unit 3 is in the busy state. The signal BUSY-N indicates whether or not the NAND flash memory 2 is in the busy state. If any command is set in the first register unit 13, the NAND flash memory 2 is in the busy state. The NOR gate 34 performs a negative OR operation on the above-described external clock EX-CLK and the result of the operation performed by the OR gate 32. The inverter 33 inverts the signal BUSY-N. The NOR gate 35 performs a negative OR operation on the clock CLK-N generated by the oscillator 12 and an output from the inverter 33. The NOR gate 36 performs a negative OR (NOR) operation on the results of the operations by the NOR gates 34 and 35. The NOR gate 36 outputs the result of the operation to the first register unit 13 as a clock MCLK-N.

The second switch unit 31 controls command setting and non-setting in the second register unit 24. As shown in FIG. 2, the second switch unit 31 includes an OR gate 37, an inverter 38, and NOR gates 39 to 41.

The OR gate 37 performs a logical OR operation on the signals BUSY-A and BUSY-N. The NOR gate 39 performs a negative OR (NOR) operation on the external clock EX-CLK and the result of the operation performed by the OR gate 37. The inverter 38 inverts the signal BUSY-A. The NOR gate 40 performs a negative OR (NOR) operation on the clock CLK-A generated by the oscillator 23 and an output from the inverter 38. The NOR gate 41 performs a negative OR (NOR) operation on the results of the operations by the NOR gates 39 and 40. The NOR gate 41 outputs the result of the operation to the second register unit 24 as a clock MCLK-A.

The above-described clocks MCLK-N and MCLK-A control the setting of commands in the first register unit 13 and the second register unit 24. FIG. 3 illustrates the relationship between the state of the NAND flash memory 2 and SRAM unit 3 and the clocks MCLK-N and MCLK-A. FIG. 3 shows how the clocks MCLK-N and MCLK-A are generated by the circuit configuration in FIG. 2.

As shown in FIG. 3, if both the NAND flash memory 2 and the SRAM unit 3 are in a ready state (BUSY-N=BUSY-A=“L”), the external clock EX-CLK is supplied which serves as the clocks MCLK-N and MCLK-A. This enables the both the first and second register units 13 and 24 to load instructions from the host apparatus.

Then, if the NAND flash memory is in the ready state (BUSY-N=“L”) and the SRAM unit 3 is in the busy state (BUSY-A=“H”), the clock MCLK-N is constant at an “H” level, that is, the clock MCLK-N is disabled. Thus, the command setting is inhibited in the first register unit 13. On the other hand, the clock CLK-A serving as the clock MCLK-A is supplied to the second register unit 24.

Then, if the NAND flash memory is in the busy state (BUSY-N=“H”) and the SRAM unit 3 is in the ready state (BUSY-A=“L”), the clock MCLK-A is constant at the “H” level, that is, the clock MCLK-N is disabled. Thus, the command setting is inhibited in the second register unit 24. On the other hand, the clock CLK-N serving as the clock MCLK-N is supplied to the first register unit 13.

### 4. Details of the First and Second Register Units 13 and 24

Now, the first and second register units 13 and 24 will be described in detail. As described above, the first register unit 13 includes the first command registers 14 for the respective commands, and the first register unit 13 includes the first command registers 14 for the respective commands. The first and second command registers 14 and 26 will be described below.

### 4.1 Configuration of the First and Second Command Registers 14 and 26

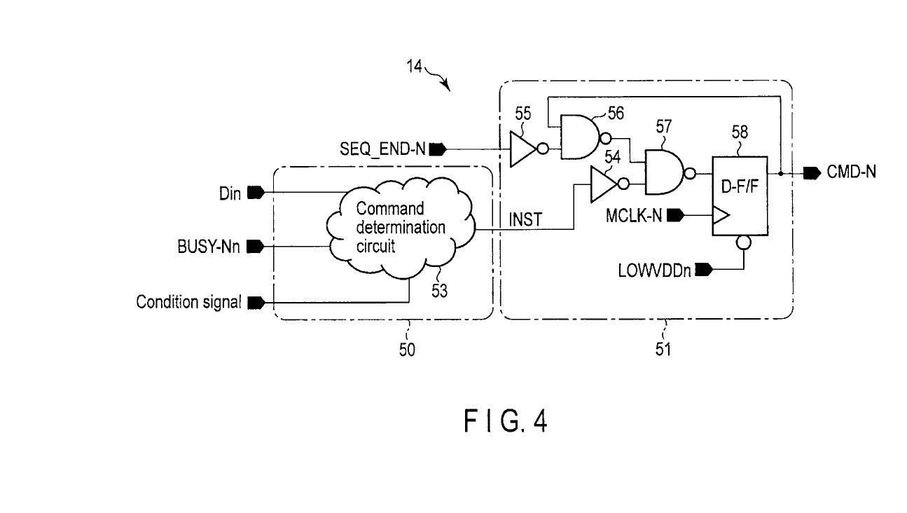

FIG. 4 is a circuit diagram of the first command register 14. As shown in FIG. 4, the first command register 14 generally includes a setting unit 50 and a holding unit 51.

The setting unit 50 is a circuit block for receiving an instruction Din (write instruction, read instruction, and erase instruction) input by the host apparatus and setting the instruction. The setting unit 50 includes a command determination circuit 53. The command determination circuit 53 performs a logical operation for determining whether or not conditions for setting of an instruction are satisfied, based on the instruction Din, an inverted busy signal BUSY-Nn (n at the end of this signal name is indicative of an inverted signal; BUSY-Nn denotes the inverted signal of BUSY-N), and as required, a condition signal. In accordance with the result of the operation, the command determination circuit 53 outputs an instruction signal INST. If the instruction is set, the signal INST is asserted (in the present example, at the “H” level).

The holding unit 51 comprises inverters 54 and 55, NAND gates 56 and 57, and a D-flipflop 58. The inverter 54 inverts the signal INST. The inverter 55 inverts a signal SEQ_END-N. The signal SEQ_END-N is adapted to reset (negate) a command CMD-N at the end of a sequence. The signal SEQ_END-N is generated by the sequencer 11 and asserted at the “H” level in the present embodiment. The NAND gate 55 performs a negative AND (NAND) operation on an output from the inverter 55 and data held in the D-flipflop 58. The NAND gate 57 performs a negative AND (NAND) operation on an output from the inverter 54 and the result of an operation performed by the NAND gate 56. The D-flipflop 58 loads the result of an operation performed by the NAND gate 57, in synchronism with the clock MCLK-N. When the “H” level is loaded into the D-flipflop 58, the command CMD-N corresponding to the first command register 14 is set. The D-flipflop 58 is provided with a signal LOWVDDn. The signal is asserted (in the present example, at the “L” level) when the semiconductor device 1 is powered off. The signal forcibly clears the set command CMD-A and is provided by, for example, the sequencer 11.

As described above, the first command register 14 including the setting unit 50 and the holding unit 51 is provided for each command. Only one of the plurality of first command registers 14 can set a command. In the description below, the command set in the first command register 14 is expressed as the signal CMD-N if the command is not distinguished from the other commands. When the write command, the read command, and the erase command are specified, the commands are expressed as CMD-WR, CMD-RD, and CMD-ER.

Furthermore, the signal BUSY-N corresponds to the logical sum (OR) of the commands CMD-N output by the plurality of first command registers 14. That is, the signal BUSY-N is asserted when the command CMD-N in any of the first command registers 14 is set. The signal BUSY-N is generated by, for example, the first sequencer 11.

The configuration of the second command register 26 is similar to that of the first command register 14 except for an input signal. That is, the second command register 26 receives, as inputs, a signal BUSY-An instead of the signal BUSY-Nn, the clock MCLK-A instead of the clock MCLK-N, and a signal SEQ_END-A instead of the signal SEQ_END-N. The signal SEQ_END-A is adapted to reset (negate) a command CMD-A at the end of a sequence. The signal SEQ_END-A is generated by the sequencer 22. Furthermore, the name of a set command is expressed as the command CMD-A. When a lock command and an unlock command are specified, the commands are expressed as CMD-LCK and CMD-ULCK.

The signal BUSY-A in the SRAM unit 3 corresponds to the logical sum (OR) of the commands CMD-A output by the plurality of second command registers 26. That is, the signal BUSY-A is asserted when the command CMD-A any of the second command registers 26 is set. The signal BUSY-A is generated by, for example, the second sequencer 22.

### 4.2 Operation of the First and Second Command Registers 14 and 26

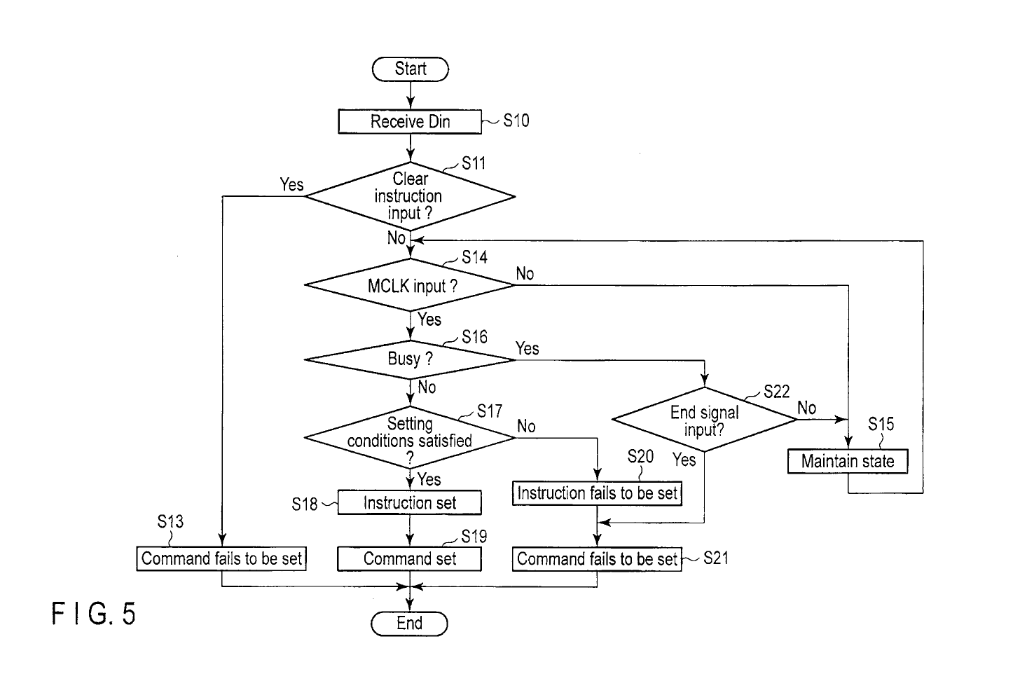

Now, operation of the first command register 14 shown in FIG. 4 will be described with reference to FIG. 5. FIG. 5 is a flowchart illustrating the flow of operations performed by the first command register 14 for setting a command.

As shown in FIG. 5, the first command register 14 first receives the signal Din via SRAM 20 (step S10). As described above, the signal Din is the data write instruction, read instruction, or erase instruction provided by the host apparatus. The signal Din is input to the command determination circuit 53.

With the clear instruction (LOWVDDn) provided (step S11, YES), no command is set regardless of the logical level of the instruction signal INST (step S13). In other words, in this case, the command in the D-flipflop 58 is forcibly reset.

With the clear instruction not provided (step S11, NO) and the clock MCLK-N also not provided (step S14, NO), the D-flipflop 58 maintains the current state (step S15).

With the clock MCLK-N provided (step S14, YES), the NAND flash memory 2 in the ready state (step S16, NO), and the instruction setting conditions in the command determination circuit 53 satisfied (step S17, YES), the instruction corresponding to the first command register 14 is set (step S18). That is, the signal INST=“H”. The signal INST is then loaded into the D-flipflop 58 in synchronism with the clock MCLK-N to set the CMD-N (step S19).

If the setting conditions are not satisfied in step S17 (step S17, NO), the instruction fails to be set (step S20, INST=“L”). The command is not set (step S21).

Furthermore, in step S16, with the NAND flash memory 2 in a busy state (step S16, YES) and an end signal SEQ_END-N input (step S22, YES), the command is not set (step S21). That is, in this case, the command in the D-flipflop 58 is forcibly reset.

In step S22, with the signal SEQ_END-N not input (step S22, NO), the D-flip flop 58 maintains the current state (step S15).

The above-described operations also apply to the second command register 26.

### 5. Detailed Operation of the Semiconductor Device 1 During Input of an Instruction

Now, operations performed by the semiconductor device 1 during input of an instruction will be described focusing particularly on the switch unit 4, the first and second register sections 13 and 24, the oscillators 12 and 23, and the first and second sequencers 11 and 22.

### 5.1 First Example

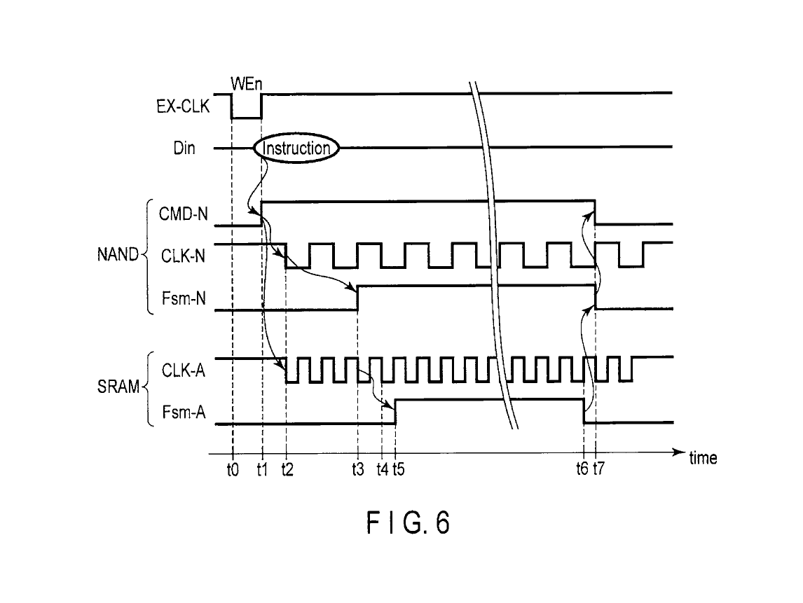

First, a case where a command is set in the first register unit 13 will be described with reference to FIG. 6. FIG. 6 is a timing chart of various signals.

Both the NAND flash memory 2 and the SRAM unit 3 are assumed to be in the ready state before a time to.

As shown in FIG. 6, at the time t0, an external clock (write enable signal WEn) is input. At a rising edge of the external clock, the instruction Din is loaded into the semiconductor device 1 (time t1). The instruction Din sets the command CMD-N in one of the first command registers 14 at the time t1. That is, in one of the first command registers 14, the command determination circuit 43 sets the signal INST to the “H” level. The signal is then loaded into the D-flipflop 58 in synchronism with the clock MCLK-N (at this point of time, the external clock EX-CLK; see FIG. 2 and FIG. 3).

In response to the setting of the command CMD-N in the first command register 14, the oscillator 12 starts generating a clock CLK-N at a time t2. The clock CLK-N is provided to the first sequencer 11 and the first register unit 13. The clock CLK-N may be provided to the NAND core unit 10, though this is not shown in FIG. 1.

Moreover, in response to the setting of the command CMD-N in the first command register 14, the signal BUSY-N is set to the “H” level. Thus, the switch unit 4 outputs the clock CLK-N as the clock MCLK-N to make the clock MCLK-A constant at the “H” level, that is, to disable the clock MCLK-A. This prevents the flip flop 58 of the second command register 26 from loading a signal. As a result, the setting of the command is inhibited in the second command register 26. On the other hand, the flip flop 58 of the first command register 14 is provided with the clock CLK-N. The first command register 14 continues to hold the command CMD-N.

Furthermore, the setting of the command CMD-N and the generation of the clock CLK-N allows the first sequencer to initiate operation. A signal Fsm-N in FIG. 6 is a start signal for the first sequencer 11 and is at the “H” level while the first sequencer is in operation. When started, the first sequencer 11 carries out processing required to execute the instruction Din to control operation of the NAND core unit 10. Additionally, to allow the SRAM unit 3 to operate, the oscillator 23 of the SRAM unit 3 is started at the time t2 owing to the setting of the command CMD-N. The oscillator 23 then starts to generate a clock CLK-A. The clock CLK-A is provided to the second sequencer 22, SRAM 20, and the ECC unit 21.

The first sequencer 11 instructs the second sequencer 22 to initiate operation. Thus, the second sequencer 22 initiates operation at a time t5 after the clock CLK-A starts to be generated. The signal Fsm-A in FIG. 6 is a start signal for the second sequencer 22. The period of the “H” level of the signal Fsm-A corresponds to a period in which the second sequencer 22 is in operation. Upon initiating operation as described above, the second sequencer 11 operates under the control of the first sequencer 11 until the processing set in the first command register 14 ends. That is, in the present example, the first sequencer 11 operates as a master sequencer, and the second sequencer 22 operates as a slave sequencer.

To end the operation, the second sequencer 22 stops operating at a time t6, for example, in accordance with an instruction from the first sequencer 11 (Fsm-A=“L”). In response, the first sequencer 11 resets the command in the first command register 14 at a time t7. For example, the first sequencer 11 asserts the signal SEQ_END-N. This resets the command in the first command register 14 to stop the operation of the first sequencer 11.

### 5.2 Second Example

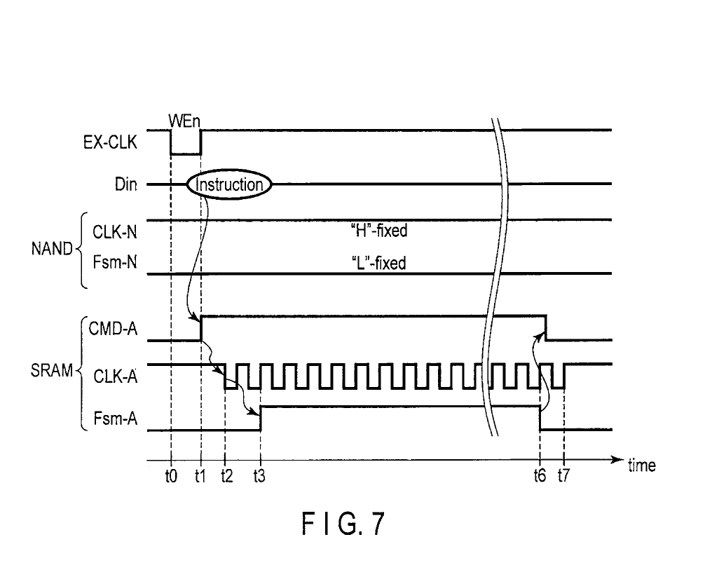

Now, a case where a command is set in the second register unit 24 will be described with reference to FIG. 7. FIG. 7 is a timing chart of various signals.

As is the case with FIG. 6, both the NAND flash memory 2 and the SRAM unit 3 are assumed to be in the ready state before the time to.

As shown in FIG. 6, at the time t0, the external clock (write enable signal WEn) is input. At a rising edge of the external clock, the instruction Din is loaded into the semiconductor device 1 (time t1). The instruction Din sets the command CMD-A in one of the second command registers 26 at the time t1. That is, in one of the second command registers 26, the command determination circuit 43 sets the signal INST to the “H” level. The signal is then loaded into the D-flipflop 58 in synchronism with the clock MCLK-A (at this point of time, the external clock EX-CLK; see FIG. 2 and FIG. 3).

In response to the setting of the command CMD-A in the second command register 14, the oscillator 23 starts generating a clock CLK-A at the time t2. The clock CLK-A is provided to the second sequencer 22, SRAM 20, and the ECC unit 21.

Moreover, in response to the setting of the command CMD-A in the second command register 26, the signal BUSY-A is set to the “H” level. Thus, the switch unit 4 outputs the clock CLK-A as the clock MCLK-A to make the clock MCLK-N constant at the “H” level, that is, to disable the clock MCLK-N. This prevents the D-flipflop 58 of the first command register 14 from loading a signal. As a result, the setting of the command is inhibited in the second command register 14. On the other hand, the D-flipflop 58 of the second command register 26 is provided with the clock CLK-A. The second command register 26 continues to hold the command CMD-A.

Furthermore, the setting of the command CMD-A and the generation of the clock CLK-A allows the second sequencer to initiate operation. The second sequencer 22 having initiated operation carries out processing required to execute the instruction Din to control operation of the SRAM 20 and the ECC unit 21. Unlike in the first example, in the second example, the operation is completed in the SRAM unit, and the first sequencer 11 is not started. The second sequencer 22 operates in accordance with instructions received directly from the host apparatus rather than via the first sequencer 11. That is, the second sequencer 22 operates independently of the first sequencer 11.

To end the operation, the second sequencer 22 stops operating by asserting the signal SEQ_END-A by itself without receiving any instruction from the first sequencer 11 (time t6).

5.3 Third example

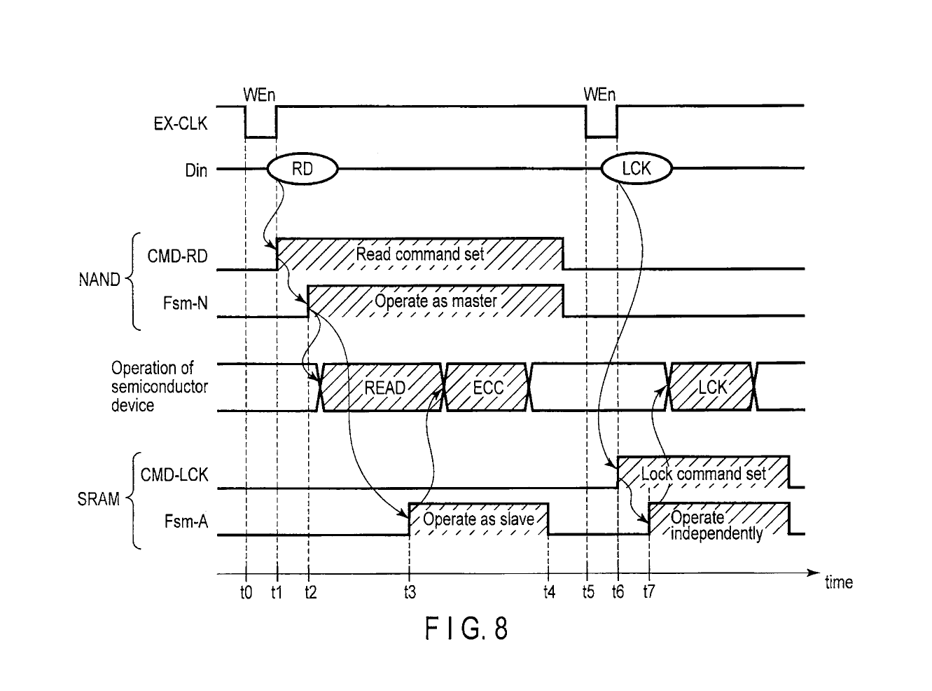

Now, a more specific flow of operation will be described with reference to a third example. FIG. 8 is a timing chart of various signals transmitted if the data read instruction and then the lock instruction are received from the host apparatus.

As shown in FIG. 8, at the time t0, the write enable signal WEn is input. At a rising edge of the write enable signal WEn, the read instruction RD is loaded (time t1). At the time t1, the command CMD-RD in the first command register 14 is set. The command CMD-RD allows the first sequencer 11 to initiate operation (Fsm-N=“H”, the time t2). Moreover, an instruction from the first sequencer 11 allows the second sequencer 22 to initiate operation (Fsm-A=“H”, the time t3). That is, the first and second sequencers 11 and 22 operate in a master-slave relationship.

In the NAND flash memory 2, data is read from the memory cell array into the sense amplifier in the NAND core unit 10 under the control of the first sequencer 11. Furthermore, data is read from the sense amplifier into the ECC unit 21 based on the control of the first sequencer 11. In the SRAM unit 3, the ECC unit 21 carries out a data ECC process based on the control of the second sequencer 22. The data subjected to the ECC process is stored in SRAM 20.

After the data read operation ends (time t4), the write enable signal WEn is input again at the time t5. At a rising edge of the write enable signal. WEn, the lock instruction LCK is loaded (time t6). At the time t6, the lock command CMD-LCK in the second command register 26 is set. The command CMD-LCK allows the second sequencer 22 to initiate operation (Fsm-A=“H”, the time t7). In this case, the command in the first command register 14 fails to be set, preventing the first sequencer 11 from operating, while allowing the second sequencer 22 to operate independently.

### 6. Effects of the Present Embodiment

As described above, in the configuration according to the present embodiment, the first sequencer 11, which operates with the low-speed clock CLK-N, is used as a master sequencer, whereas the second sequencer 22, which operates with the high-speed clock CLK-A, is used as a slave sequencer. When a process is carried out which is completed by the operation of only the second sequencer 22 without the need for the operation of the first sequencer 11, the corresponding command is input directly to the second sequencer 22. This allows the second sequencer 22 to operate independently of the first sequencer 11.

Such a configuration enables commands requiring high-speed operations to be processed with using the low-speed master sequencer.

For example, the NAND flash memory and SRAM are different in operating speed. That is, SRAM can operate faster than the NAND flash memory. Thus, the NAND flash memory and SRAM are controlled by the respective sequencers operating at different speeds.

In this case, if the SRAM sequencer is used as a master sequencer, a sequence of processing from command input to end are basically carried out in synchronism with the high-speed clock. However, with diversified product specifications, using the sequencer operating with the high-speed clock, as a master sequencer, may be inconvenient because, for example, a plurality of product modes need to be dealt with.

Thus, in this case, the sequencer operating in synchronism with the low-speed clock may be used as a master sequencer. That is, the NAND flash memory sequencer is used as a master sequencer, while the SRAM sequencer is used as a slave sequencer. As described above, changing the relationship between the master and the slave allows the user's various requests to be met.

In this case, the SRAM sequencer receives instructions from the NAND flash memory sequencer, which lies in a clock domain different from that of the SRAM sequencer. That is, signals cross the different clock domains (clock domain crossing [CDC]). This may result in malfunctioning. Measures against the clock domain crossing (CDC measures) include a method of receiving signals via a two-stage flip-flop.

Then, the low-speed sequencer, serving as a master sequencer, needs to be started in synchronism with the low-speed clock. Moreover, when transmitted from the master sequencer to the slave sequencer and from the slave sequencer to the master sequencer, signals need to be received across the two flipflops, each synchronizing with the receiving clock. Thus, the delivery of the signals requires much time.

However, in the present embodiment, for processes that can be completed by the slave sequencer 22, the corresponding commands can be provided directly to the slave sequencer 22. Hence, no problems associated with the CDC measures occur. This allows improvement of reliability of processes requiring high-speed operations and corresponding to instructions such as the lock instruction.

### SECOND EMBODIMENT

Now, a semiconductor device according to a second embodiment will be described. The present embodiment corresponds to an arrangement for performing a reset operation in the above-described first embodiment. The other arrangements and operations are similar to those of the first embodiment, and will not be described below.

### 1. General Configuration of the Semiconductor Device 1

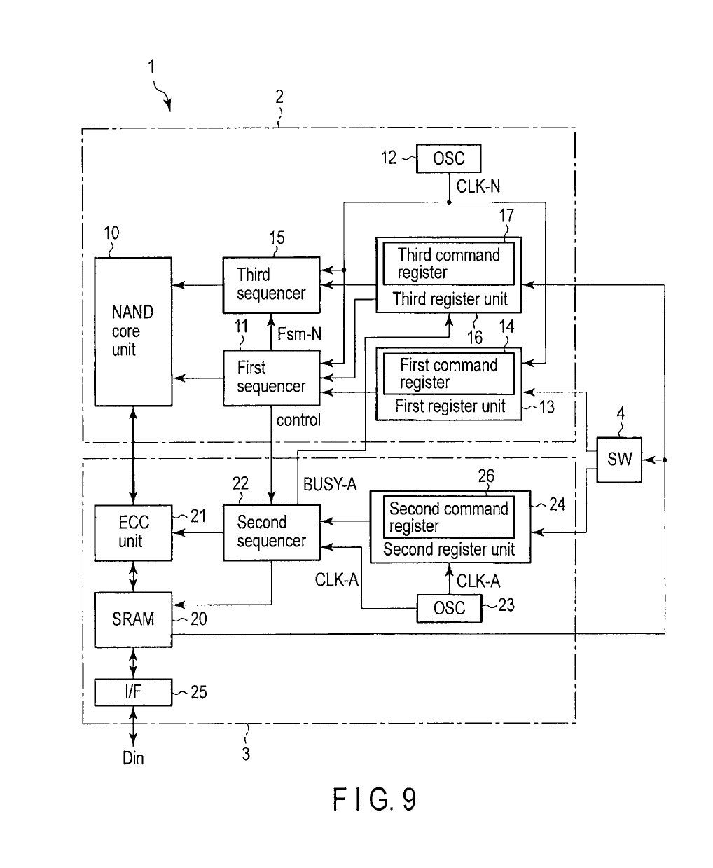

FIG. 9 is a block diagram of the semiconductor device 1 according to the present embodiment. As shown in FIG. 9, the semiconductor device 1 according to the present embodiment corresponds to the configuration in FIG. 1 described in the first embodiment and in which the NAND flash memory 2 further includes a third sequencer 15 and a third register unit 16.

The third sequencer 15 and the third register unit 16 are configured to perform a reset operation for recovering the NAND flash memory 2 and the SRAM unit 3 to initial states thereof. An externally input reset instruction needs to be accepted even if the NAND flash memory 2 and/or the SRAM unit 3 is in the busy state.

The third register unit 16 includes a third command register 17. The third register unit 16 sets and holds a reset command CMD-RST in accordance with a reset instruction input by an external host apparatus via the SRAM unit 3.

The third sequencer 15 controls the operation of the NAND flash memory 2 based on the set command CMD-RST in the third command register 17 and in synchronism with the clock CLK-N. That is, the third sequencer 15 carries out processing required for the reset operation.

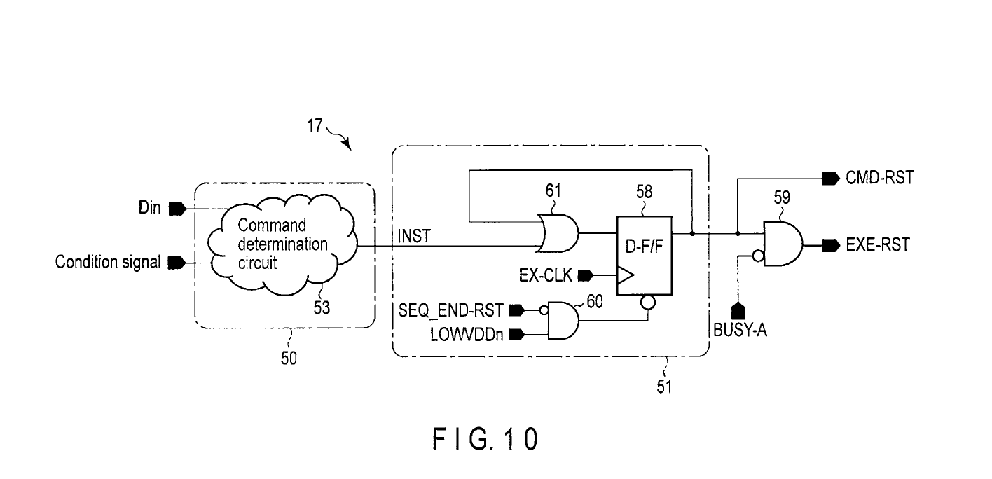

Now, the configuration of the third register unit 16 will be described. FIG. 10 is a circuit diagram of the third command register 17. As shown in FIG. 10, the third command register 17 is obtained by modifying the configuration in FIG. 4 described in the above-described first embodiment as follows. That is, the command determination circuit 53 sets the reset instruction INST based on the reset instruction Din and a required condition signal without relying on the busy signal BUSY-Nn.

Instead of the end signal SEQ_END-N, a signal SEQ_END-RST is input which allows the command CMD-RST to be reset (negated) at the end of a reset sequence. The signal SEQ_END-RST is issued by the third sequencer 15.

Instead of the clock MCLK-N, a clock EX-CLK is input to the D-flipflop 58.

The third register section 16 further includes a NAND gate 59. The NAND gate 59 performs a logical AND operation on the command CMD-RST and an inverted busy signal BUSY-An. The NAND gate 59 then outputs the result of the operation as a reset execution signal EXE-RST.

Moreover, the holding unit 51 lacks the inverters 54 and 55 and the NAND gates 56 and 57, and instead includes an AND gate 60 and an OR gate 61. The AND gate 60 performs a logical AND operation on a signal LOWVDDn issued by the third sequencer 15 and an inverted end signal SEQ_END-RSTn. Then, the result of the operation is asserted to forcibly reset the D-flipflop 58. The OR gate 61 performs a logical OR operation on the signal INST and the command CMD-RST. The D-flipflop 58 loads the result of the operation performed by the OR gate 61, in synchronism with the clock EX-CLK.

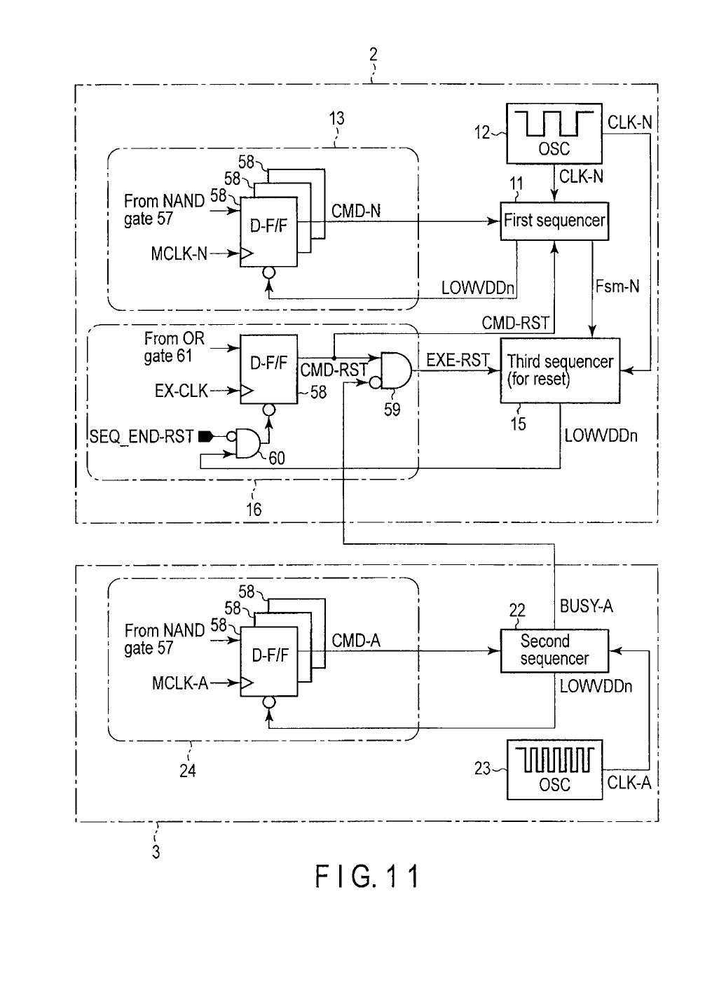

Now, the relationship between the register units 13, 16, and 24 and the sequencers 11, 15, and 22 will be described with reference to FIG. 11. FIG. 11 is a block diagram of a partial area of the semiconductor device 1 according to the present embodiment, and particularly shows the first to third register units 13, 16, and 24, the first to third sequencers 11, 15, and 22, and the oscillators 12 and 23.

As shown in FIG. 11, the relationship between the first register unit 13 and the first sequencer 11 and the relationship between the second register unit 24 and the second sequencer 22 are similar to those in the first embodiment. On the other, hand, the third sequencer 15 initiates a reset operation based on the signal EXE-RST and a signal Fsm-N output by the first sequencer 11 instead of the command CMD-RST.

The sequencer may be provided for each command. That is, separate sequencers may be provided for the read, write, erase, and reset operations, respectively. However, one sequencer capable of carrying out a plurality of functions may implement functions corresponding to a plurality of commands. This also applies to the first embodiment.

The specific flow of the reset operation will be described below.

### 2. Operations

### 2.1 Operation of the Third Register Unit 16

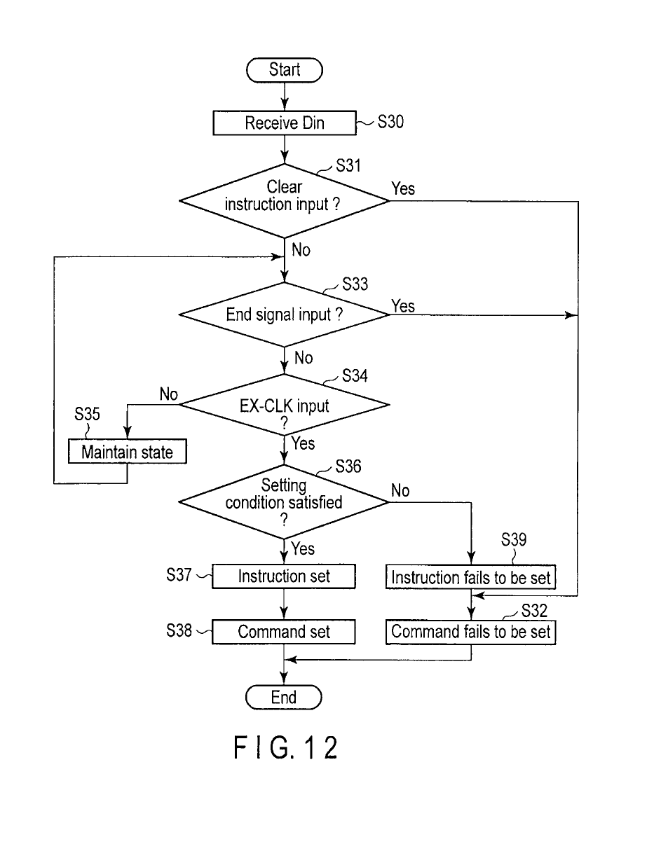

First, the operation performed in the third register unit 16 until the reset command CMD-RST is set will be described with reference to FIG. 12. FIG. 12 is a flowchart illustrating the flow of processing in the third register unit 16.

As shown in FIG. 12, first, the host apparatus inputs a reset signal Din to the semiconductor device (step S30). The signal Din is input to the command determination circuit 53.

If the clear instruction has been given (step S31, YES), the reset command CMD-RST fails to be set regardless of the logical level of the reset instruction signal INST (step S32). In other words, in this case, the command in the D-flipflop 58 is forcibly reset. As described with reference to the circuit diagram in FIG. 10, the clear instruction in the third register 16 is the result of a logical AND operation on the inverted signal of the end signal SEQ_END-RST and the signal LOWVDDn.

Even if the clear instruction has not been given (step S31, NO), the command also fails to be set (step S32) if the end signal SEQ_END-RST has been given (step S33, YES). That is, also in this case, the command in the D-flipflop 58 is forcibly reset.

If the end signal has not been given (step S33, NO) and the external clock EX-CLK has not been input (step S34, NO), the current state of the D-flipflop 58 is maintained (step S35).

If the external clock EX-CLK has been input (step S34, YES) and the command setting conditions for the command determination circuit 53 are satisfied (step S36, YES), the reset instruction INST is set (step S37). The signal INST is loaded into the D-flipflop 58 in synchronism with the clock EX-CLK to set the command CMD-RST (step S38).

In step S36, if the setting conditions are not satisfied (step S36, NO), the instruction fails to be set (step S39, INST=“L”). The reset command CMD-RST thus fails to be set (step S32).

### 2.2 Sequencer Reset Operation

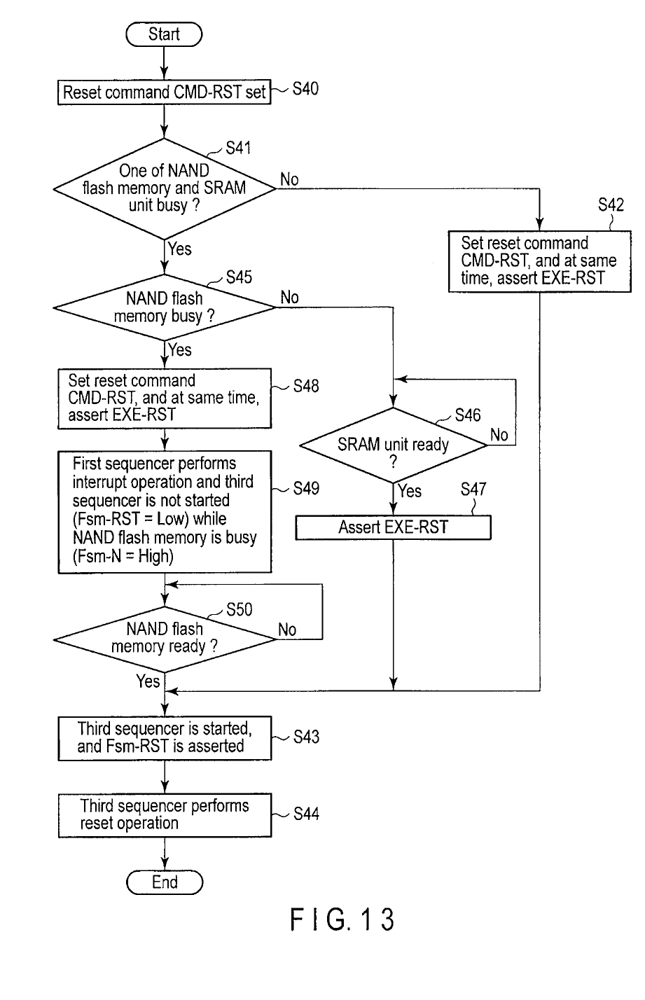

Now, the operation performed after the reset command CMD-RST is set will be described with reference to FIG. 13. FIG. 13 is a flowchart illustrating the operation of the semiconductor device 1.

As shown in FIG. 13, first, the reset command CMD-RST is set according to the flowchart in FIG. 12 (step S40). If both the NAND flash memory 2 and the SRAM unit 3 are in the ready state (step S41, NO), the command CMD-RST is set, and at the same time, the signal EXE-RST is asserted. Thus, the third sequencer 15 is started to assert the signal Fsm-RST (step S43). Then, the third sequencer 15 initiates a reset operation (step S44).

Even if the NAND flash memory is in the busy state

(YES in step S41 and YES in step S45), that is, any command CMD-N in one of the first command registers 14 has been set, the command CMD-RST is set, and at the same time, the signal EXE-RST is asserted (step S48). However, at this stage, the third sequencer 15 is not started yet. That is, in response to the setting of the reset command CMD-RST, the first sequencer 11 performs an operation of interrupting a process being currently executed (step S49). During this period, the NAND flash memory 2 is still in the busy state (Fsm-N=“H”), and the third sequencer 15 is thus not started.

When the interruption operation of the first sequencer 11 is completed to change the NAND flash memory 2 to the ready state (step S50, YES), the third sequencer 15 is started (step S43) and initiates the reset operation (step S44).

On the other hand, if the SRAM unit 3 is in the busy state (YES in step S41 and NO in step S45), that is, any command CMD-A in one of the second command registers 26 has been set, the signal EXE-RST remains negated because the signal BUSY-A=“H”. When the SRAM unit 3 changes from the busy state to the ready state (step S46, YES), the signal EXE-RST is asserted to start the third sequencer 15 (step S43). Thus, the reset operation is started (step S44).

### 2.3 Specific Example of Operation

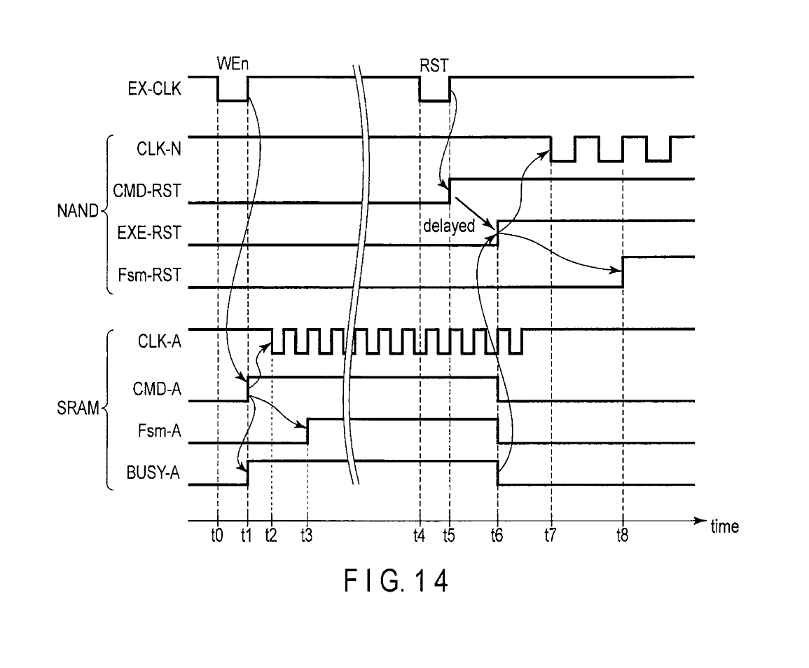

A specific operation performed when the reset instruction is input while the SRAM unit 3 is in the busy state will be described with reference to FIG. 14. FIG. 14 is a timing chart of various signals.

As shown in FIG. 14, at the time t1, the command CMD-A is set in the second command register 26. The SRAM unit 3 becomes busy state. Then, in the SRAM unit 3, the oscillator 23 generates a clock CLK-A (time t2). The second sequencer 22 initiates processing in synchronism with the clock CLK-A (time t3).

It is assumed that at the time t4, when the SRAM unit 3 is in operation, the host apparatus inputs the reset instruction RST to the semiconductor device. Then, at the time t5, the third command register 17 sets the reset command CMD-RST in response to the reset instruction RST (CMD-RST=“H”). However, at this point of time, the SRAM unit 3 is in the busy state (BUSY-A=“H”). Thus, the signal EXE-R is at the “L” level, preventing the third sequencer 15 from being started.

At the time t6, the processing by the SRAM unit 3 ends to make the SRAM unit 3 ready state (BUSY-A=“1”). Then, the result of operation of the AND gate 59 is inverted. That is, the signal EXE-RST is set to the “H” level. Thus, the NAND flash memory changes to the busy state. At the time t7, the oscillator 12 starts generating a clock CLK-N. Furthermore, the third sequencer 15 is started (Fsm-RST=“H”) to initiate the reset operation.

### 3. Effects According to the Present Embodiment

As described above, the present embodiment enables the appropriate reset operation to be achieved using the simple configuration.

The reset command needs to be able to be accepted even when the NAND flash memory 2 or the SRAM unit 3 is in the busy state. Furthermore, the operation of the sequencer in the busy state cannot be stopped as required and needs to be interrupted at an appropriate timing.

In this connection, in the configuration according to the present embodiment, the reset command CMD-RST is converted into the signal EXE-RST based on the busy signal BUSY-A on the slave (SRAM unit 3) side. Then, based on the signal EXE-RST, the third sequencer 15 for reset is started. More specifically, if a logical operation is performed on the command CMD-RST and the signal BUSY-A to set the command RST and the slave side is in the ready state, then the signal EXE-RST is asserted.

If the reset instruction is input while the master side (NAND flash memory 2) is in the busy state, the third sequencer 15 synchronizes the command CMD-RST. The third sequencer 15 further carries out appropriate processing to change to the interrupt operation, thus ending the sequence. In this case, since the slave side is in the ready state, the signal EXE-RST is also asserted when the command CMD-RST is set. However, conditions for starting the third sequencer 15 include the signal Fsm-N=“L”. That is, the third sequencer 15 is not started to initiate the reset operation until the operation of the first sequencer 11 is stopped.

On the other hand, if the reset instruction is input while the slave side is in the busy state, the third sequencer 15 has difficulty determining the appropriate period for the second sequencer which lies in a different clock domain. However, in the present embodiment, the signal EXE-RST is asserted at a timing when the slave side becomes the ready state. That is, the signal EXE-RST is asserted asynchronously with the clock CLK-N. In other words, the present embodiment can create the same situation as occurs in the case where the command CMD-RST is not set while the slave side is in the busy state and where the reset instruction is input immediately after a change to the ready state. Thus, the third sequencer 15 can appropriately initiate the reset operation without the need to determine the status of processing by the second sequencer 22.

The subsequent operation is the same as that in the case where the reset instruction is received while both the NAND flash memory 2 and the SRAM unit 3 are in the ready state. That is, processing involved in the reset operation is completed only by the NAND flash memory. Thus, the NAND flash memory 2 has a simple circuit configuration.

Furthermore, in this case, the reset operation requires no signal transmissions between the second sequencer 22 and the third sequencer 15. Only transferring the busy signal BUSY-A to the third command register 17 is sufficient. This eliminates the need for CDC measures. Also in this connection, the configuration of the NAND flash memory 2 can be simplified. In addition, the number of circuit elements can be reduced.

### THIRD EMBODIMENT

Now, a semiconductor device according to a third embodiment will be described. The present embodiment relates to the details of the interrupted state of the first sequencer 11 described above in the second embodiment.

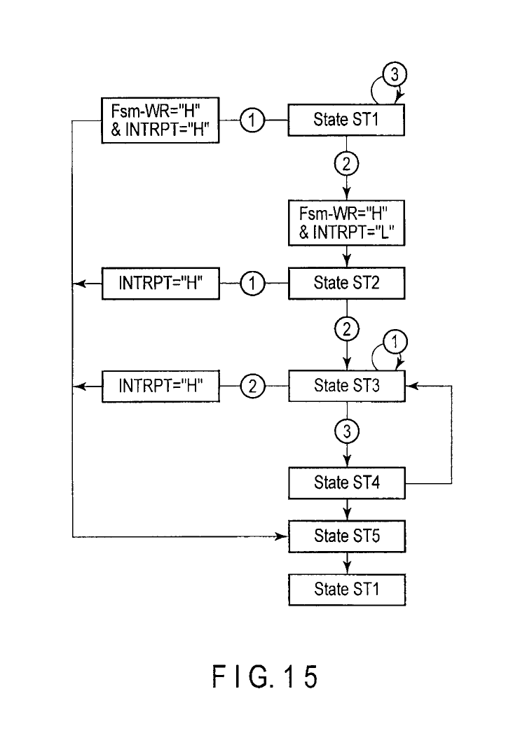

FIG. 15 is a state transition diagram of a state machine for the first sequencer 11 which is used when data write is carried out. In FIG. 15, encircled numbers indicate the priorities of transitions.

As shown in FIG. 15, the state machine has, for example, states ST1 to ST5.

In the state ST1, no write command is provided. The state ST1 thus corresponds to, for example, an idle state. When, in the state ST1, a write command is provided to start the first sequencer 11 (Fsm-WR=“H”), the state machine changes to the state ST2. However, in this state ST1, if an interrupt instruction INTRPT is issued, changing to the state ST5 is given the highest priority. In the state ST5, the first sequencer carries out processing required to stop the operation of the first sequencer 11. Stopping the operation allows the state machine to return to the state ST1.

Also in the state ST2, the issuance of the instruction INTRPT allows the state machine to change directly to the state ST5. Without the instruction INTRPT, the state machine changes to the state ST3. In the state ST3, data is programmed in memory cells. Also in the state ST3, the instruction INTRPT allows the state machine to change directly to the state ST5. However, in the state ST3, unlike in the state ST2, changing to the state ST5 is given the second highest priority. The highest priority is given to ending of the sequence of processing (for example, the operation of the NAND core 10) in this state. Thus, if the instruction INTRPT is issued during the processing in the state ST3, the state machine does not change to the state ST5 until the sequence of processing is completed. That is, a change to the state ST5 is not carried out immediately but after the processing is interrupted at the appropriate timing in the state machine.

With the processing in the state ST3 completed and the instruction INTRPT not issued, the state machine changes to the state ST4. In the state ST4, for example, a voltage (for example, a program voltage applied to word lines) required for the subsequent program operation is set. Changing from the state ST4 to the state ST5 is not carried out by the interrupt instruction INTRPT. That is, if the instruction INTRPT is issued in the state ST4, the state machine changes from the state ST4 to the state ST3 and then to the state ST5 when the processing in the state ST3 ends. Furthermore, when all of the sequence of the write process ends, the state machine changes from the state ST4 to the state ST5.

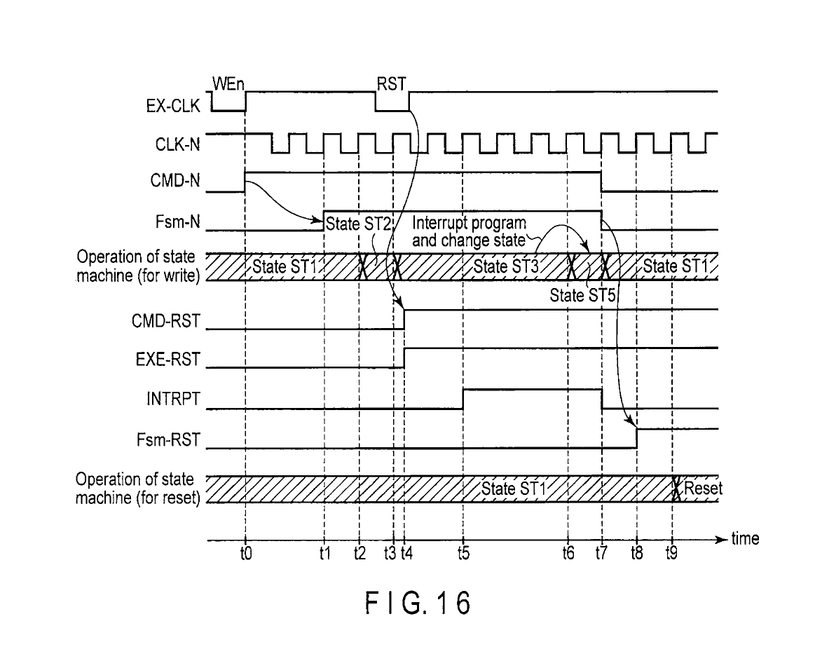

Now, a specific exam of the case where the reset instruction is received during data write will be described with reference to FIG. 16. FIG. 16 is a timing chart of various signals.

As shown in FIG. 16, when the write command CMD-N is set at the time t0, the first sequencer 11 is started at the time t1 (Fsm-N=“H”). The state machine for the first sequencer 11 changes from the state ST1 to the state ST2 at the time L2. Moreover, at the time t3, which is one clock after the time t2, the state machine changes from the state ST2 to the state ST3 to initiate a program operation.

It is assumed that, at the time t4 during the program operation, the reset instruction is input to set the command CMD-RST. Since the SRAM unit 3 is in the ready state, the command CMD-RST is set, and at the same time, the signal EXE-RST is asserted.

Furthermore, in response to the setting of the command, the interrupt instruction INTRPT is issued inside the first sequencer 11 at the time t5. Thus, for example, at the time t6, when the processing by the NAND core unit 10 is completed, the state machine interrupts the program and changes to the state ST5. Changing to the state ST5 resets the command CMD-RST and sets the signal Fsm-N to the “L” level.

When the first sequencer thus changes from the busy state to the ready state, the signal Fsm-RST is asserted at a time t8. As a result, the third sequencer 15 for reset changes from the idle state (state ST1) to an active state to initiate the reset operation.

As described above, when the reset instruction is received while the NAND flash memory 2 is in the busy state, the device may operate according to this embodiment. That is, the first sequencer 11 and the third sequencer 15 are controlled by the same clock CLK-N, eliminating the need for CDC measures.

In contrast, if the reset instruction is received while the NAND flash memory 2 is in the busy state, the device may operate according to the second embodiment. In this case, the timing when the signal EXE-RST is asserted is delayed by the signal BUSY-A. This allows the reset operation to be initiated at the appropriate timing without the need for CDC measures.

### [Modifications]

As described above, the semiconductor device 1 according to the present embodiment has a first operation mode (where a command is set in the first command register 14) and a second operation mode (where a command is set in the second command register 26). The semiconductor device 1 includes a first sequencer 11 operating at a first frequency and a second sequencer 22 operating at a second frequency that is higher than the first frequency. In the first operation mode, the first sequencer 11 operates in accordance with an instruction received from an external apparatus (host and/or controller), and the second sequencer 22 operates under the control of the first sequencer 11. In the second operation mode, the second sequencer 22 operates in accordance with instructions received from an external apparatus, with the operation of the first sequencer 11 stopped.

In the present example, when high-speed processing by the second sequencer 22 is required, the corresponding instruction can be given directly to the second sequencer 22 in the second operation mode. Thus, the semiconductor device 1 that can operate at high speed can be provided.

In the above-described embodiments, the NAND flash memory 2 and the SRAM 20 are embedded in the semiconductor memory system by way of example.

However, the present embodiments are not limited to a system with a semiconductor memory. Any semiconductor system may be used provided that the system includes a plurality of clock domains.

Further, in the above embodiments, the external apparatus which issues the instruction to the registers and sequencers is a host apparatus by way of example. However, the external apparatus may be a controller of the semiconductor device 1. For example, when the controller receives a request for accessing data from the host apparatus, the controller issues the instruction to the semiconductor device 1.

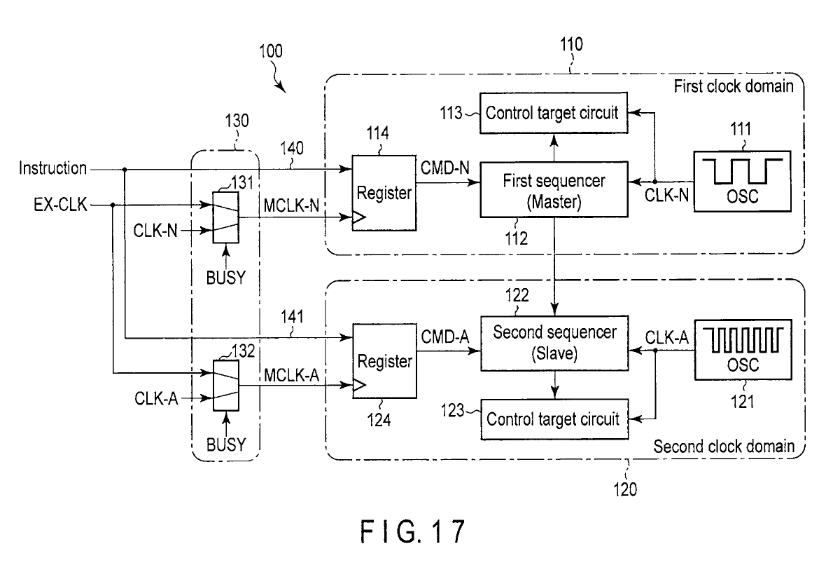

FIG. 17 is a block diagram of a semiconductor device according to a modification of the above-described embodiments. As shown in FIG. 17, a semiconductor device 100 includes a first clock domain 110 and a second clock domain 120.

The first clock domain 110 operates with a first clock CLK-N having a first frequency and generated by a first oscillator. The first clock domain 110 is controlled by a first sequencer 112. The second clock domain 120 operates with a second clock CLK-A having a frequency higher than the first frequency and generated by a second oscillator 121. The second clock domain 120 is controlled by a second sequencer 122. Control target circuits 113 and 123 controlled by the first and second sequencers 112 and 122 are not only the semiconductor memory but various circuit blocks such as a command determination circuit and a wireless communication device.

In this configuration, the semiconductor device 100 has a first operation mode and a second operation mode. In the first operation mode, the second sequencer 122 operates under the control of the first sequencer 112 without receiving any instruction from an external apparatus. On the other hand, in the second operation mode, the second sequencer 122 operates in accordance with instructions received directly from an external apparatus, with the operation of the first sequencer 112 stopped.

The semiconductor device 100 further includes a first path 140 through which instructions are transferred to the first sequencer 112 and a second path 141 provided separately from the first path 140 and through which instructions are transferred to the second sequencer 122. The semiconductor device 100 uses the first path 140 or the second path 141 depending on a command. That is, commands requiring operations of the first clock domain 110 are provided to the first sequencer 112 through the first path 140. On the other hand, commands requiring only operations of the second domain 120 and not any operation of the first clock domain are provided to the second sequencer 122 through the second path 141.

The semiconductor device may further includes a first register 114 provided on the first path 140 to receive instructions for the first sequencer 112, a second register 124 provided on the second path 141 to receive instructions for the second sequencer 122, and a selection unit 130 configured to select clocks to be provided to the first and second registers 114 and 124. The selection unit 130 includes a selector 131. The selector 131 provides the clock CLK-N with the first frequency to the first register 114 without providing any clock to the second register 124 during operation of the first sequencer 112. Moreover, the selection unit 130 includes a selector 132. The selector 132 provides the clock CLK-A with the second frequency to the second register 124 without providing any clock to the first register 114 during operation of the second sequencer 122.

As described above, the above-described embodiment is applicable not only to semiconductor memory systems but to semiconductor devices in general.

In the first and second embodiments, the NAND flash memory 2 and the SRAM unit 3 are integrated together on one chip by way of example. A specific example of such a memory system may be a flash memory like “OneNAND (registered trade name)”. However, the present embodiments are not limited to one chip integration. The NAND flash memory 2 and the SRAM unit 3 may be implemented on separate semiconductor chips. Alternatively, in the SRAM unit 3, for example, the second sequencer 22, the ECC unit 21, and SRAM 20 may be implemented on different chips.

Furthermore, in the above-described embodiments, the NAND flash memory is used as a main storage. However, the present embodiments are not limited to the NAND flash memory. The main storage may be any other type of flash memory or a ferroelectric memory, a magnetic random access memory using magnetoresistance elements as memory cells, ReRAM (Resistance Random Access Memory) using variable resistive elements, or any other semiconductor memory.

Moreover, the semiconductor device 1 may include the NAND flash memory 2 and the ECC unit 21 and not SRAM 20. In this case, the NAND flash memory 2 may form a first clock domain, and the ECC unit 21 may form a second clock domain.

Furthermore, in the above-described embodiments and the modification in FIG. 12, the semiconductor device includes two clock domains by way of example. However, the semiconductor device may include at least three clock domains. In this case, a register may be provided in each of the clock domains so that instructions can be input directly to all the clock domains. Alternatively, instructions may be input directly and exclusively to either a clock domain serving as a master or at least two clock domains serving as slaves.

Furthermore, the circuit configurations in FIG. 2, FIG. 4, and FIG. 10 described above in the embodiments are only illustrative. The present embodiments are not limited to these circuit configurations. Any circuit configuration may be used provided that the circuit configuration enables, for example, the operations illustrated in FIG. 3, FIG. 5 to FIG. 7, FIG. 12 to FIG. 14, FIG. 15, and FIG. 16. Moreover, the order of the processes described above and illustrated in the flowcharts may be changed wherever possible.

Moreover, in the above-described embodiments, the commands processed by the first sequencer 11 are the read command CMD-RD, the write command CMD-WR, and the erase command CMD-ER by way of example. The commands processed by the second sequencer 22 are the lock command CMD-LCK and the unlock command CMD-ULCK. However, available commands are not limited to those described above.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device, including a first mode and a second mode, comprising:
a first sequencer operating at a first frequency; and
a second sequencer operating at a second frequency higher than the first frequency;
wherein in the first mode, the first sequencer operates in accordance with an instruction received from an external apparatus, and the second sequencer operates under control of the first sequencer, and
in the second mode, the second sequencer operates in accordance with an instruction received from the external apparatus, and the operation of the first sequencer is stopped.

2. The device according to claim 1, further comprising:
a first path through which an instruction is transferred to the first sequencer; and
a second path provided separately from the first path and through which an instruction is transferred to the second sequencer,
wherein the first path or the second path is used depending on a command.

3. The device according to claim 2, further comprising:
a first register provided on the first path to receive the instruction for the first sequencer;
a second register provided on the second path to receive the instruction for the second sequencer; and
a selection unit selecting clock to be provided to the first register or the second register,
wherein, during operation of the first sequencer, the selection unit provides the clock with the first frequency to the first register, and
during operation of the second sequencer, the selection unit provides the clock with the second frequency to the second register.

4. The device according to claim 3, wherein the selection unit provides an external clock to both the first sequencer and the second sequencer, when neither of the first sequencer and the second sequencer is in operation.

5. The device according to claim 4, wherein the first register and the second register are provided with a clock by the selection unit upon receiving a command signal, and sets a command corresponding to the command signal when a command setting condition is set.

6. The device according to claim 3, further comprising:
a third sequencer operating at the first frequency and performing a reset operation of the semiconductor device; and
a third register receiving a reset instruction required to start the third sequencer,
wherein upon receiving the reset instruction during operation of the second sequencer, the third register delays start of the reset operation until operation of the second sequencer is stopped.

7. The device according to claim 6, wherein the second sequencer generates a busy signal indicating that the second sequencer is in operation,
the third register sets a reset command in response to an reception of the reset instruction, and performs a logical operation on the reset command and the busy signal to generate a reset execution signal, and
the third sequencer performs the reset operation in response to assertion of the reset execution signal.

8. The device according to claim 7, wherein if the reset command is set while the first sequencer is in operation, the first sequencer executes an interrupt process,
after the interrupt process causes the first sequencer to stop operating, the third sequencer is started.

9. The device according to claim 8, wherein the first sequencer includes a plurality of states, and a priority of the interrupt process varies depending on the state.

10. A method for operating a semiconductor device, the method comprising:
in a first mode,
setting a first command in a first register in accordance with a received instruction;
generating a first clock and a second clock with a frequency higher than a frequency of the first clock, in response to the first command;
causing a first sequencer synchronizing with the first clock to initiate operation; and
causing a second sequencer synchronizing with the second clock to initiate operation, the second sequencer operating under control of the first sequencer; and
in a second mode,
setting a second command in a second register in accordance with a received instruction;
generating the second clock in response to the second command; and
causing the second sequencer to initiate operation,
wherein, in the second mode, the first clock is not generated, and the first sequencer is not started.

11. The method according to claim 10, wherein a path through which an instruction is transferred to the first sequencer is different from a path through which an instruction is transferred to the second sequencer.

12. The method according to claim 11, wherein, during operation of the first sequencer, the first clock is provided to the first register, and
during operation of the second sequencer, the second clock is provided to the second register.

13. The method according to claim 12, wherein an external clock is provided to both the first sequencer and the second sequencer, when neither of the first sequencer and the second sequencer is in operation.

14. The method according to claim 13, wherein the first register and the second register are provided with a clock upon receiving a command signal, and sets a first command and a second command in accordance with the command signal when a command setting condition is set.

15. The method according to claim 12, further comprising:
setting a reset command in a third register receiving a reset instruction required to start the third sequencer,
causing the third sequencer synchronizing with the first clock to perform a reset operation of the semiconductor device,
wherein upon receiving the reset instruction during operation of the second sequencer, the third register delays start of the reset operation until operation of the second sequencer is stopped.

16. The method according to claim 15, wherein the second sequencer generates a busy signal indicating that the second sequencer is in operation,
the third register sets a reset command in response to an reception of the reset instruction, and performs a logical operation on the reset command and the busy signal to generate a reset execution signal, and
the third sequencer performs the reset operation in response to assertion of the reset execution signal.

17. The method according to claim 16, wherein if the reset command is set while the first sequencer is in operation, the first sequencer executes an interrupt process,
after the interrupt process causes the first sequencer to stop operating, the third sequencer is started.

18. The method according to claim 17, wherein the first sequencer includes a plurality of states, and a priority of the interrupt process varies depending on the state.
